(19) United States
(12) Patent Application Publication
(10) Pub. No.: US 2026/0119021 A1
(43) Pub. Date: Apr. 30, 2026

(54) Dynamic Frames Within A Shared Window Space

(71) Applicant: Oracle International Corporation, Redwood Shores, CA (US)

(72) Inventor: Jennifer Darmour, Seattle, WA (US)

(73) Assignee: Oracle International Corporation, Redwood Shores, CA (US)

(21) Appl. No.: 19/302,829

(22) Filed: Aug. 18, 2025

Related U.S. Application Data
(60) Provisional application No. 63/712,062, filed on Oct. 25, 2024.

(51) Int. Cl. G06F 3/04845

(52) U.S. Cl. CPC G06F 3/04845

(57) ABSTRACT

Techniques for dynamically resizing frames in a graphical user interface (GUI) window are disclosed. The system presents a GUI window on a display screen. The system presents, within the GUI window, a first frame that displays a first set of content and a second frame that displays a second set of content. The frames share space within the GUI window. The system detects a content transition, modifying the first set of content, corresponding to the first frame. In response to the content transition, the system increases the size of the first frame and decreases the size of the second frame without changing the size of the GUI window.

### BENEFIT CLAIMS; RELATED APPLICATIONS; INCORPORATION BY REFERENCE

This application claims the benefit of U.S. Provisional Patent Application 63/712,062, filed Oct. 25, 2024, which is hereby incorporated by reference.

### TECHNICAL FIELD

The present disclosure relates to trigger-based dynamic resizing of frames within a window space shared by multiple frames in a graphical user interface (GUI).

### BACKGROUND

An application that provides multiple functions to users may provide separate interfaces that correspond to the different functions. When two or more functions are related to one another, the user may need to change contexts within the application, for example, by switching between windows or tabs, to access different components of a workflow. The user may not be able to view relevant information from the different contexts concurrently.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for dynamically resizing frames in a GUI window in accordance with one or more embodiments;

FIGS. 3A, 3B, 4A, 4B, 5A, and 5B illustrate various examples of GUI windows in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DYNAMIC FRAME RESIZING ARCHITECTURE
3. DYNAMICALLY RESIZING FRAMES
4. EXAMPLE EMBODIMENT
5. PRACTICAL APPLICATIONS, ADVANTAGES, AND IMPROVEMENTS
6. COMPUTER NETWORKS AND CLOUD NETWORKS
7. HARDWARE OVERVIEW
8. MISCELLANEOUS; EXTENSIONS

### 1. General Overview

One or more embodiments automatically resize frames within a GUI window when content in a frame changes. A frame with new or changed content is enlarged to allow a user to view and interact with the content, while another frame is reduced to allow the other frame to grow. The frames remain accessible within the window to preserve context that may exist within the content of the frames and to allow the user to quickly change focus from one frame to another. In an example, the system presents content in an object frame and chat messages within a chat frame. While a user is interacting with the object frame, the object frame is enlarged, while the chat frame is reduced. When a new chat message is received, the system enlarges the chat frame and reduces the object frame. After a threshold period of time with no new chat messages and/or when the content in the object frame changes, the system reduces the chat frame and enlarges the object frame.

In an embodiment, a system presents a GUI window on a display with multiple frames sharing space in the GUI window. The system presents a first set of content in a first frame and a second set of content in a second frame. The system detects a content transition, modifying the first set of content. In response to the content transition, the system increases the size of the first frame and decreases the size of the second frame without changing the size of the GUI window.

In an example, a medical practice management application GUI window has one object frame that displays content and interface elements that allows a user to schedule an appointment, for example, by selecting a date and time, a location, and an individual to meet with during the appointment. A chat frame displays a chat interface and shows an interface element that allows a user to start composing a message and may display a most recent message to or from the user exchanged with another entity associated with the medical practice, such as a scheduling coordinator, a nurse, a chat bot, or a physician. While the user is interacting with the object frame, a chat message arrives and is presented in the chat interface. The system enlarges the chat frame to show the new chat message along with other interface elements to enable the user to read, compose, and send a message. The system also reduces the object frame to accommodate the enlarged chat frame while displaying a reduced amount of information about the appointment scheduling in progress.

One or more embodiments described in this Specification and/or recited in the claims may not be included in this General Overview section.

### 2. Dynamic Frame Resizing Architecture

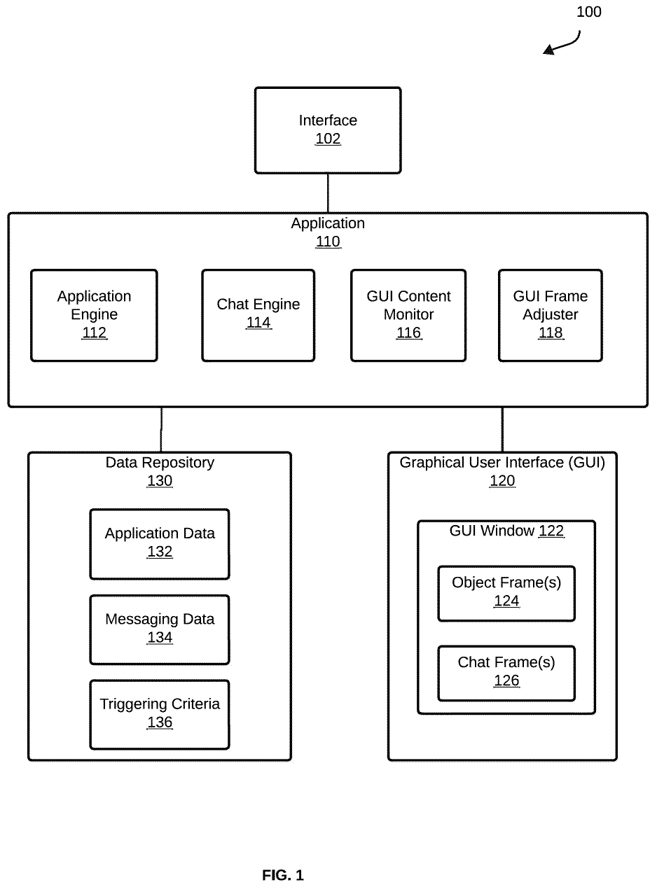

FIG. 1 illustrates a system 100 in accordance with one or more embodiments. As illustrated in FIG. 1, system 100 includes an application 110, a graphical user interface (GUI) 120, a data repository 130, and an interface 102. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

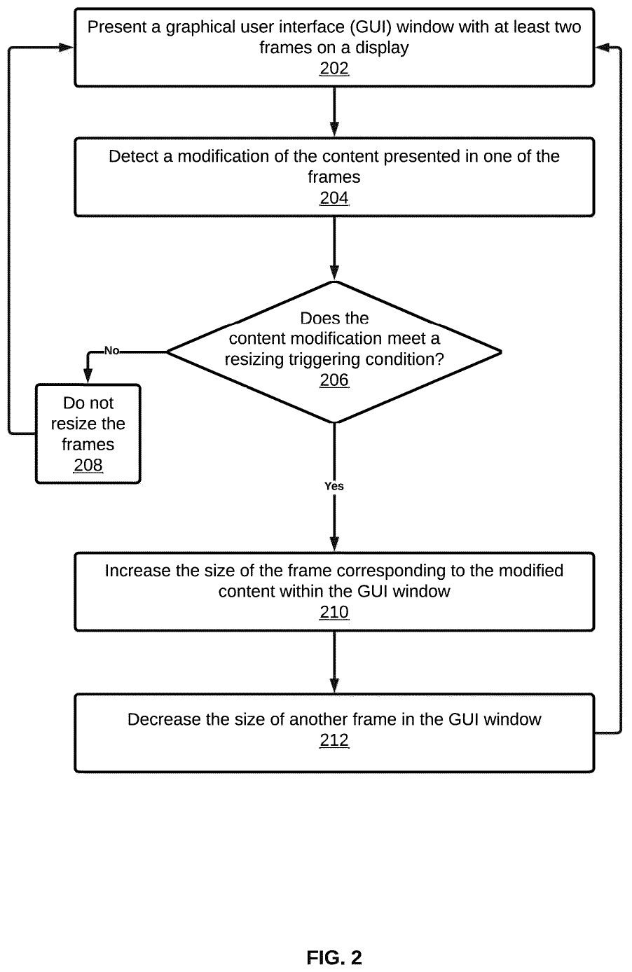

In one or more embodiments, application 110 refers to hardware and/or software configured to perform operations described herein, including operations for dynamically resizing frames within a GUI window. Examples of operations for dynamically resizing frames within a GUI window are described below with reference to FIG. 2.

The application 110 may generally use, create, and/or store application data 132 related to the function of the application. For example, if the application is a medical practice management application, the application data may include appointment data, medical record data, and personnel data. If the application is a collaboration application, the application data may include documents, change-history data for documents, and scheduling-workflow data. The application 110 may enable users to send and receive communications, such as chat messages, electronic mail messages, and text messages. The application 110 may store the communications as messaging data 134.

The application 110 may include one or more functional components, such as an application engine 112, a chat engine 114, a GUI content monitor 116, and a GUI frame adjuster 118. More, fewer, or different functional components may be used. The application engine 112 may include instructions for performing the operations for the primary function of the applications 110, e.g., creating and/or modifying application data 132, performing calculations, or enabling collaboration.

The chat engine 114 may operate to provide a chat function. For example, the chat engine 114 may provide a chat frame 126 within the GUI 120 that permits a user to compose, send, receive, and read messages exchanged with another entity. The chat engine 114 may deliver a message to a recipient, such as another user or to an automated chat agent (e.g., a chatbot). The chat engine 114 may store messages in the messaging data 134.

Although shown as a component of application 110, the chat engine 114 may be a stand-alone chat application or a component of an operating system. When not a component of application 110, the chat engine 114 may allow application 110 to resize the chat frame and select the messages that are presented in the chat frame.

The GUI content monitor 116 may monitor content presented in an object frame 124 of the GUI 120 to detect when the presented content changes or when a characteristic of the displayed content changes. The GUI content monitor 116 may determine when a change to the content or to a characteristic of the content meets one or more triggering criteria 136. When the one or more triggering criteria are met, the GUI content monitor 116 may prompt the GUI frame adjuster 118 to resize one or more frames within the GUI 120.

In one or more embodiments, GUI 120 refers to hardware and/or software configured to present application components to a user on a display. The GUI may present static information and interactive elements. In one or more embodiments, GUI 120 has a GUI window 122. The GUI window 122 may have a fixed size, such as when presented on a mobile device, or the GUI window 122 may be resizable, such as when presented on a desktop display device.

GUI 120 may present two or more frames within the GUI window 122, such as an object frame 124 and a chat frame 126. GUI 120 may present application data 132 in an object frame 124. The GUI 120 may present messages in the chat frame 126 and allow a user to exchange messages with another user or with a chatbot.

In an embodiment, one frame in the GUI window has an active status, whereas the other frame, or frames, has an inactive status. An active frame may correspond to the frame associated with the last-received user input. An active frame may correspond to the frame associated with the last-modified content. An active frame may correspond to the frame explicitly selected as the active frame. During a transition event, a first frame transitions from an inactive status to an active status, and a second frame transitions from an active status to an inactive status.

The GUI frame adjuster 118 may adjust the sizes of one or more frames presented in the GUI window 122 when one or more triggering criteria 136 are met. The GUI frame adjuster 118 may increase the size of one frame with a corresponding decrease in size to one or more other frames, so the frames in the GUI window 122 are still within the bounds of the GUI window without changing the size of the GUI window.

Triggering criteria 136 can include a transition event where an inactive frame becomes the active frame, and the active frame becomes an inactive frame. Triggering criteria 136 can include a modification of the content being presented in a frame and/or new content being presented in the frame. Triggering criteria 136 can include an age of the presented content exceeding a threshold age, a display time of the presented content exceeding a threshold display time, or a time since a last change exceeding an activity threshold. Triggering criteria 136 can include a change to an urgency or priority of presented content.

In one or more embodiments, a data repository 130 is any type of storage unit and/or device (e.g., a file system, database, collection of tables, or any other storage mechanism) for storing data. Furthermore, a data repository 130 may include multiple different storage units and/or devices. The multiple different storage units and/or devices may or may not be of the same type or located at the same physical site. Furthermore, a data repository 130 may be implemented or executed on the same computing system as application 110. Additionally, or alternatively, a data repository 130 may be implemented or executed on a computing system separate from application 110. The data repository 130 may be communicatively coupled to application 110 via a direct connection or via a network.

Information describing the application data 132, messaging data 134, and triggering criteria 136 may be implemented across any of components within the system 100. However, this information is illustrated within the data repository 130 for purposes of clarity and explanation.

In one or more embodiments, interface 140 refers to hardware and/or software configured to facilitate communications between a user and the application 110. Interface 140 renders user interface elements and receives input via user interface elements. Examples of interfaces include a GUI, a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 140 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 140 is specified in one or more other languages, such as Java, C, or C++.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Dynamically Resizing Frames

FIG. 2 illustrates an example set of operations for dynamically resizing frames in a GUI window in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system presents a GUI window on a display with at least two frames in the window (Operation 202). The system may display the GUI window in the entire space provided by a display, e.g., on a mobile phone screen, or in a portion of the space provided by the display. Initially, the system may allocate display space within the window to multiple frames where the individual frames are displayed within a corresponding space allocated for the frame within the window. The different frames may not overlap one another.

The different respective frames are associated with different respective content, e.g., application content in an object frame and chat messages in a chat frame. If the entirety of a set of content associated with a frame does not fit within the frame, the system may present a portion of the content in the frame. The system may select the portion of content to present according to an amount or size of the content, a size of the frame, and/or a zoom level associated with the content.

In an embodiment, the system detects a modification of the content presented in one of the frames (Operation 204). The system may detect that different content is being presented in the frame, for example, if a user follows a link that opens a different document in the frame. The system may detect that additional content is being presented in the frame, for example, when a new chat message is received in a chat frame. The system may detect that a characteristic of the content has changed. For example, the system may detect that a priority or urgency of the presented content has changed. The system may detect when a frame changes from an inactive status to an active status as a modification of the content.

In an embodiment, the system determines if the content modification meets a resizing triggering condition (Operation 206). The system may determine that content modification meets a resizing triggering condition if the frame has transitioned from an inactive status to an active status, for example, by a user action in the frame. When the content in the frame is modified, the system may determine that the content modification meets a resizing triggering condition if the modified content cannot be displayed fully in the current size of the frame. Even if the modified content can be displayed fully in the current size of the frame, if the modification of the content causes the frame to transition to an active status, the system may determine that the resizing triggering condition is met based on the modification, the transition event, or both. When a characteristic of the content changes, the system may determine that the content modification meets a resizing triggering condition. For example, if the content presented in the frame becomes more urgent or increases in priority, the system may determine that the resizing triggering condition is met. In an embodiment, if the frame is already at a maximum possible size, the system may not perform any resizing operations based on the detected content modification.

In an embodiment, when the content modification does not meet a resizing triggering condition, the system does not resize the frames based on the modified content and returns to Operation 202 (Operation 208).

In an embodiment, when the content modification meets a resizing triggering condition, the system increases the size of a first frame corresponding to the modified content within the GUI window (Operation 210). In some embodiments, a frame may have a set of predetermined sizes that the frame can have within the GUI window, and the system may select a larger size than the current size from the set of predetermined sizes for the frame. The system may calculate an area needed to present the modified or additional content and increase the frame size to the calculated area. The system may determine an amount of area that can be made available by decreasing the size of one or more other frames in the window and increasing the size of the frame to use some or all of the available area.

In an embodiment, when the system increases the size of the frame, the system presents more content associated with the frame. Additionally, or alternatively, the system may increase a zoom level for the content displayed within the increased frame size.

In an embodiment, the system decreases the size of a second frame in the GUI window (Operation 212). The system may decrease the size of the second frame simultaneously with increasing the size of the first frame. The system may decrease the size of the second frame by the amount of space allocated to the increased frame.

In an embodiment where a frame may have a set of predetermined sizes that the frame can have within the GUI window, the system may select a smaller size than the current size from the set of predetermined sizes for the frame.

When the system decreases the size of the second frame, the amount of display space used by the second frame within the GUI window is decreased. A portion of the display space that was previously used by the now-reduced sized second frame may be used for the display of another frame. The system may increase the size of another frame without necessarily changing the size of the GUI window by using the portion of the display space that is no longer being used by the reduced sized frame.

When the system decreases the size of the second frame, the system may decrease an amount of content presented in the second frame. The system may remove some content, for example, older chat messages in a chat frame, or show less text in a presentation of text. The system may replace the content with a summary or representation of the content that occupies less space in the second frame. For example, when a frame presenting appointment scheduling content is reduced, the system may present a date and time, location, and a topic of the appointment in the second frame while removing other, additional, details from the frame. The system may decrease a zoom level for the content in the frame, e.g., by reducing text or image sizes. The system may provide a scroll bar or other interface element to allow the user to navigate to content associated with the second frame that is not currently visible within the frame.

In one or more embodiments, a frame may present individual elements within the frame. For example, the system may present elements corresponding to discrete items, such as email messages, a file listing, or image thumbnails. When the frame is sufficiently large and/or has an active status, the elements may be presented without overlapping one another. When the frame is reduced, the system may present the elements in a stacked presentation where the elements overlap one another while remaining partially visible.

The system may calculate an amount of overlap to use according to the reduced size of the second frame and the respective sizes of the elements. In an example, an individual element occupies a space of 2×4 units, and four non-overlapping elements in the second frame occupy a space that is 10×4 units. When the second frame is resized to have a space of 4×4 units, the element at the top or front of the stack still occupies 2×4 units, leaving 2×4 units of space for display of the other three elements. The remaining three elements may be shown stacked below or behind the first element and protruding about 2/3 units from behind the previous element.

As a result of resizing the frames, the increased first frame may become larger than the decreased second frame. In another case, the increased first frame may become larger than a previous size of the first frame while remaining smaller than the decreased second frame. In some cases, the total area of the GUI window occupied by the frames may not change even when the sizes of the individual frames change. The size of the GUI window may remain static. When the GUI window size is not static, the frames may collectively and proportionately increase or decrease within the GUI window when the size of the GUI window changes.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

One or more embodiments automatically resize a frame in a GUI window based on an active or inactive status associated with the frame. When the inactive status of a frame transitions to an active status, the system increases the size of the frame. Conversely, when the active status of a frame transitions to an inactive status, the system decreases the size of the frame. The transition of one frame from an inactive to an active status may automatically trigger the transition of another frame from an active to inactive status. Additionally, or alternatively, a frame may transition from an active status to an inactive status in response to one or more independent triggering criteria such as user input setting an inactive status for the frame. In an example, a chat frame for displaying chat messages may automatically transition from inactive to active in response to receipt of a new chat message. The transition of the chat frame from inactive status to active status may trigger an increase in size of the chat frame and a decrease in size of one or more other frames. In some embodiments, only a single frame may be associated with an active status at any given time, whereas the other frames are associated with an inactive status. In other embodiments, multiple frames may be concurrently associated with an active status.

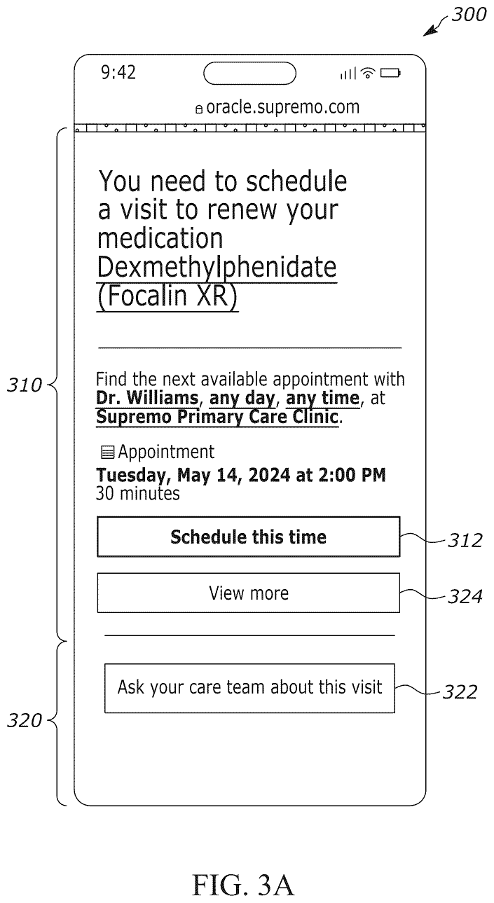

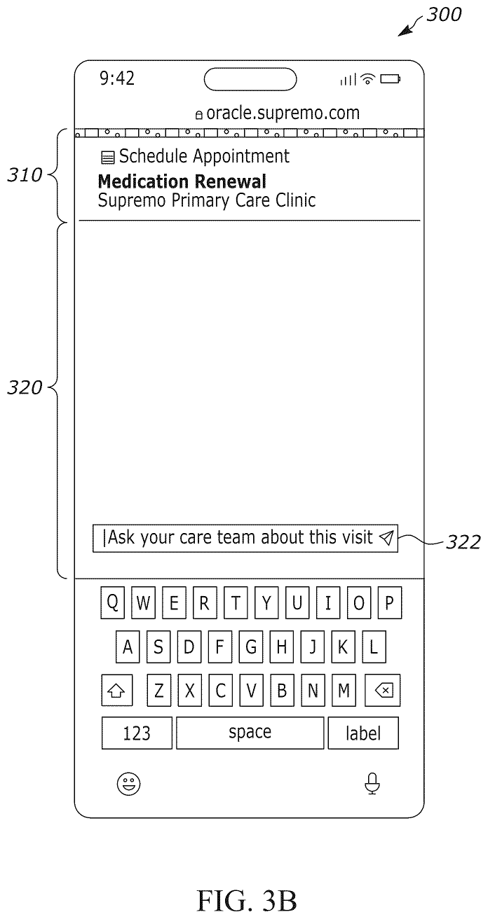

FIG. 3A illustrates an example of a GUI window 300 showing an object frame 310 and a chat frame 320 sharing the area within the window 300. The GUI window 300 may be formatted for a mobile device display. In the illustrated example, the object frame 310 is larger and occupies more surface area than the chat frame 320. The system displays information relevant to an appointment scheduling object in the object frame 310, for example, information about the purpose of the proposed appointment, in this case, renewing medication. The system can also display information in object frame 310 that indicates a proposed appointment date and time. The system can include one or more action elements, such as action elements 312 and 314, that are configured to perform an action when selected by the user.

Because the object frame 310 is active, the chat frame 320 is smaller and occupies less surface area than the object frame 310 within the window 300. The system displays a chat input field 322 in the chat frame 320. The user can enter text in the chat input field 322 to send a message to the system, for example, to a human user or to a chatbot. As shown in the example, the user has not yet selected the chat frame 320.

In one or more embodiments, the system displays a message prompt in the chat input field 322 based on the type of object represented in the object frame. In the illustrated example, because the object is an appointment object, the system displays a prompt for the user to ask a question about the visit.

In one or more embodiments, the system identifies a particular chatbot for responding to user messages based on the type of object represented in the object frame. For an appointment object type, the system may choose a scheduling chatbot. For a billing object, the system may choose a billing system chatbot.

While the illustrated examples display the active frame in a larger size than the inactive frame, some embodiments may display the active frame in a smaller size than the inactive frame. An individual frame may still increase in size when the frame transitions from inactive to active and decrease in size when the frame transitions from active to inactive, as described above. However, one frame may be maintained at a larger size compared to the other frame regardless of the active or inactive status of the frame.

FIG. 3B illustrates an example of the GUI window 300 with dynamically resized appointment object frame 310 and chat frame 320. The system resizes the frames responsive to the user selecting the chat frame 320, for example, by selecting the chat field with an input device, or by selecting keys on an input keyboard. The system may replace some or all of the information previously displayed in the expanded object frame with a representation of the object frame content, such as a summary or abbreviated version of the information in the condensed object frame. The summary or abbreviated version may include information that identifies what the object is, e.g., an appointment scheduling object, and context, e.g., medication renewal and a location for the appointment. The action elements, such as buttons or interactive elements, may be removed or disabled while the object frame 310 is condensed.

In one or more embodiments, the system may resize the object frame and chat frame incrementally. For example, the chat frame may be expanded as chat messages are received and generated with proportional condensing of the object frame. When a chat message is received, the system may expand the chat frame to display the most recent message(s), whereas the object frame is reduced until a minimum size for the object frame is reached.

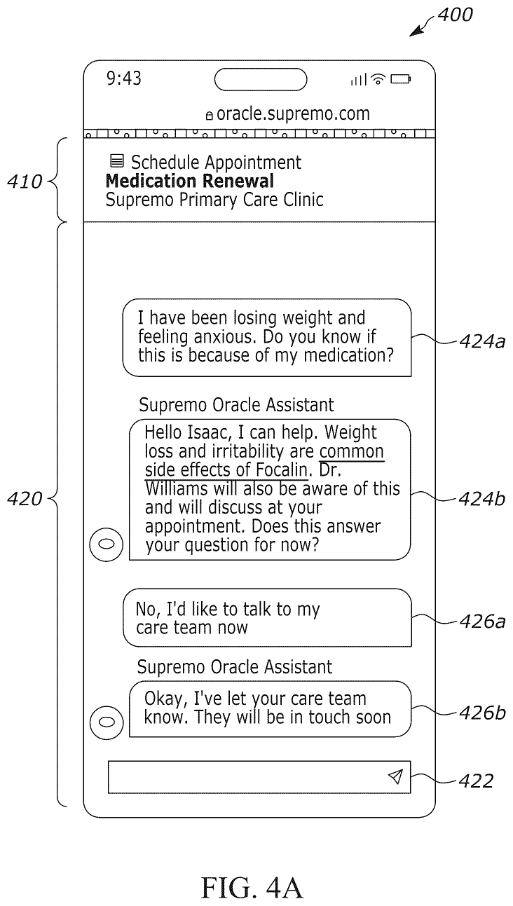

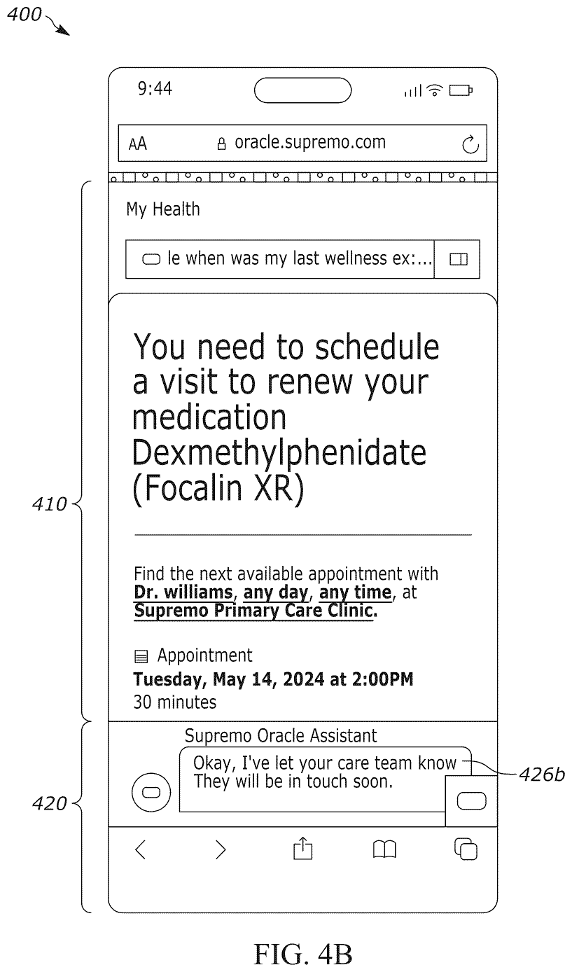

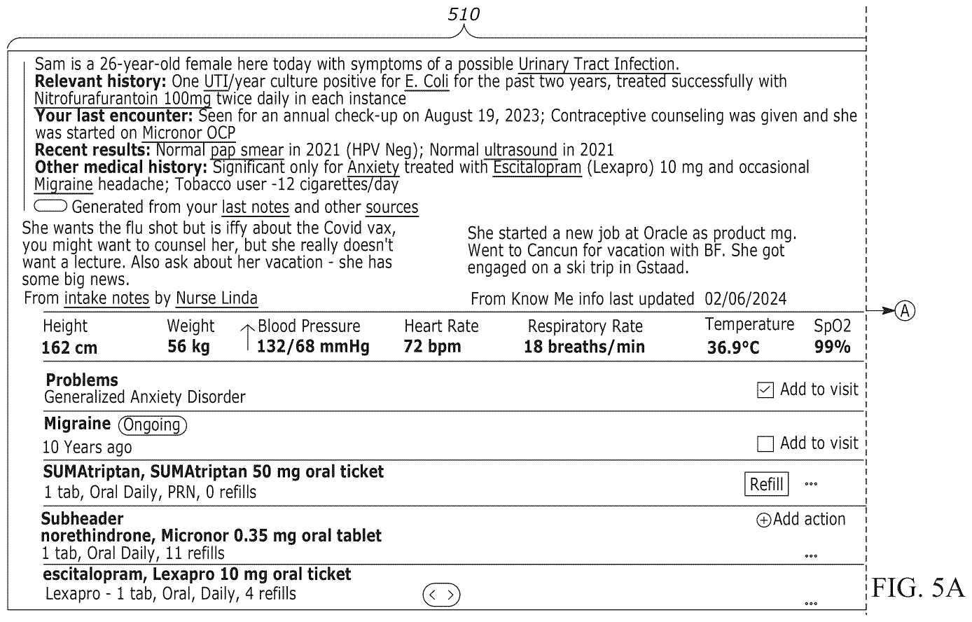

FIG. 4A illustrates an example of a GUI window 400 showing an object frame 410 and a chat conversation in a chat frame 420. Object frame 410 is reduced and condensed relative to the chat frame 420 and shows a representation of an appointment scheduling object. The chat conversation includes a set of messages 424, with messages 424a and 424c being user-generated messages and messages 424b and 424d being system-generated messages. The user can generate additional messages in the chat input field 422.

FIG. 4B represents the GUI window 400 after the user has selected the condensed object frame 410 to return to the appointment scheduling object. The system has expanded the object frame 410 and dynamically reduced the chat frame 420. The reduced chat frame 410 still shows the last chat message 424d. The reduced messaging frame may display a message input field and/or a portion of a latest message received that is relevant to the user and the appointment object. When the user subsequently selects the chat frame 420 to initiate a message or when a new message is received, the system reduces the size of the object frame and increases the size of the chat frame.

In an embodiment, a GUI displays three or more frames within a window. When a particular frame of the three or more frames transition from an inactive status to an active status, the system increases a display size of the particular frame. When a particular frame of the three or more frames transition from an active status to an inactive status, the system reduces the display size of the particular frame. Multiple inactive frames may be represented by respective interface elements that are displayed in a stack. At least a portion of each of the interface elements within the stack may be displayed. When a user selects a displayed portion of an interface element representing a particular frame, the particular frame transitions from an inactive status to an active status. The system increases the display size for the interface element, thereby increasing the size of the particular frame.

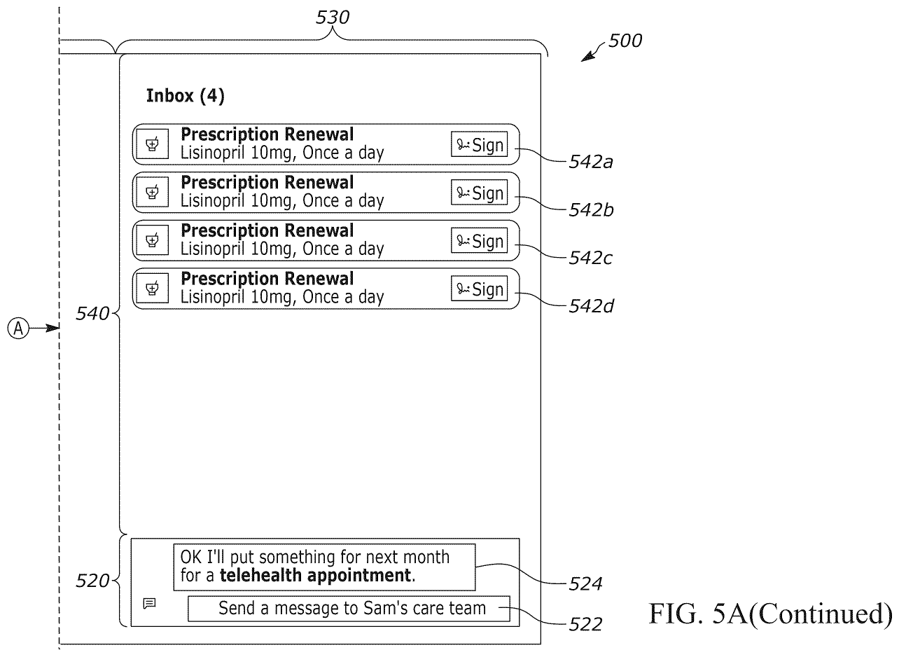

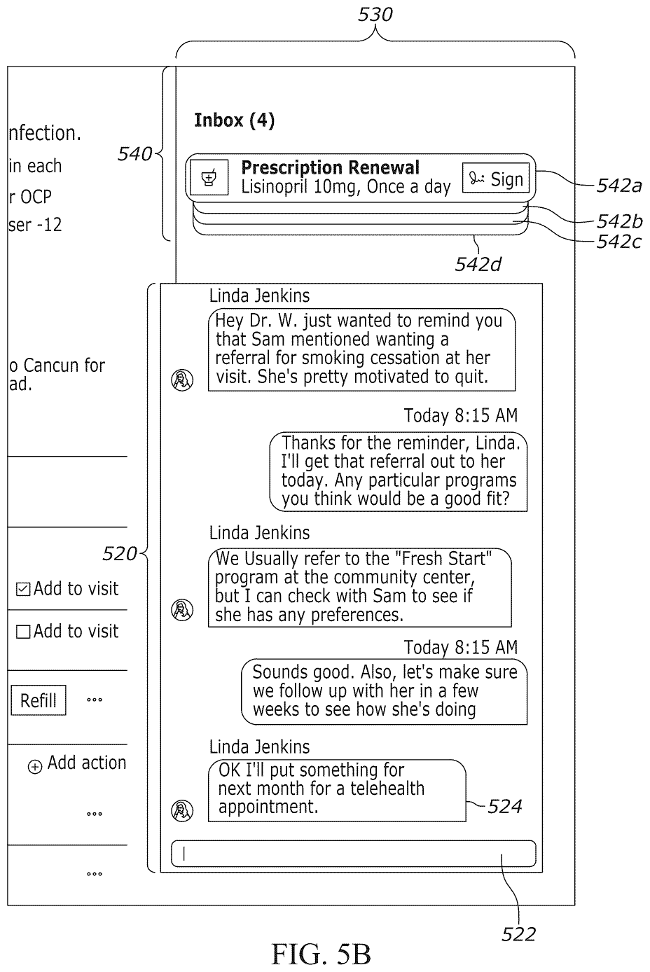

FIG. 5A illustrates an example of a GUI window 500 having a plurality of frames. The GUI window 500 may be formatted for a larger display such as for a desktop computer monitor. The GUI window 500 includes an information frame 510 and a communication frame 530. The information frame 510 displays information from the application generating the GUI window, in this example, portions of a person's electronic health record.

The communication frame 530 includes a chat frame 520 and an inbox frame 540. As seen in FIG. 5A, the chat frame 520 is condensed relative to the inbox frame 540 within the communication frame 530. The chat frame 520 shows a chat message 524 associated with the information in the information frame 510 and provides a chat input field 522. The inbox frame 540 includes a set of inbox items 542a-542d. The inbox item elements are displayed individually and separated from one another.

FIG. 5B represents the communication frame 530 after the user has selected the chat frame 520, for example, by clicking a point within the frame 530 with an input device cursor or by typing on a keyboard. In response, the system expands the chat frame 520 and condenses the inbox frame 540. In addition to condensing the surface area occupied by the inbox frame 540, the system also stacks the interface elements representing the inbox items 542. The system may stack the interface elements, so the previous bottom-most element, i.e., 542d, is at the bottom of the stack. Alternatively, the system may place the bottom-most element at the top of the stack. The system may stack the interface elements chronologically with the most recent interface element at the top of the stack. The system may condense the inbox items to a smaller area when stacking the inbox items.

In an embodiment, the system may resize the inbox frame and chat frame incrementally. For example, the chat frame may be expanded as chat messages are received and generated with proportional condensing of the inbox frame. Whenever a chat message is received, the system may expand the chat frame to display the most recent message(s) while the inbox frame is simultaneously reduced until a minimum size for the inbox frame is reached.

In an embodiment, the system may stack all of the inbox elements displayed in the expanded inbox frame. For example, if ten inbox items are shown in the expanded frame, the system will display ten stacked interface elements in the condensed frame. Alternatively, the system may stack a set of interface elements up to a predetermined number of interface elements.

In an embodiment, the system may calculate how many stacked interface elements to display according to the available surface area in the inbox frame. The system may consider the height or area of a single interface element and the height or area of the visible portion of a lower stacked element and calculate the number of elements that can be displayed in the total height available. The system may adjust the degree of overlap to fit in more interface elements. The system may stack the interface elements with less overlap when more height or surface area is available. The system may dynamically adjust the number of stacked interface elements, the amount of overlap of the stacked interface elements, or both, in response to a change in the surface area of the inbox frame.

### 5. Practical Applications, Advantages, and Improvements

One or more embodiments preserve context and workflow among different components of an application by resizing frames that display various forms of content according to changes to the content. The system enlarges a frame when the frame becomes active through one or more triggering conditions. The system reduces a frame when the frame becomes inactive either due to another frame becoming active or due to a triggering condition associated with the frame. The system focuses on recent or otherwise active content while allowing the user to easily view and access other content in the other frames of the application without having to switch to a different tab, window, or screen.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

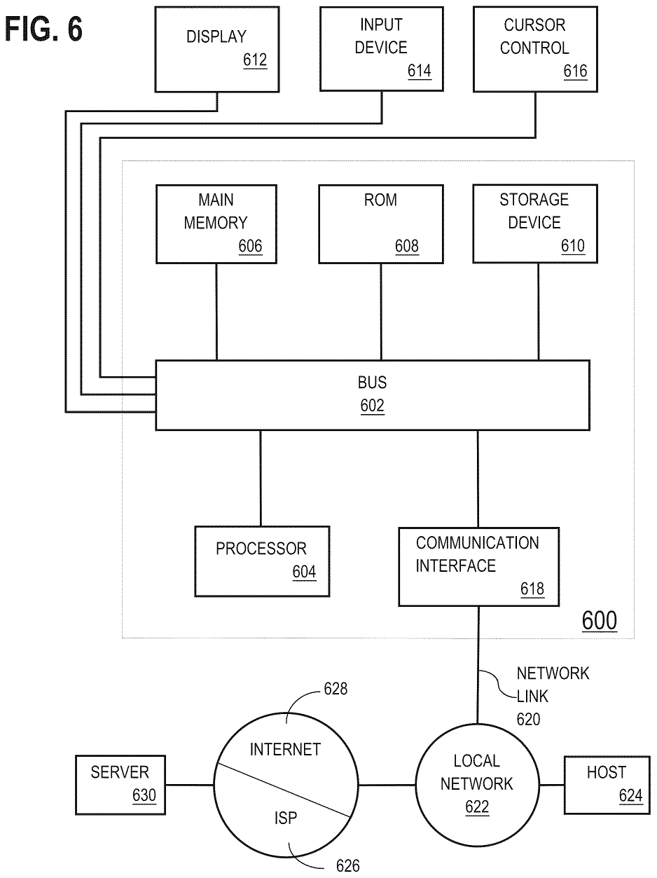

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk, optical disk, or a Solid-State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
presenting a graphical user interface (GUI) window on a display;
presenting, within the GUI window, a plurality of frames comprising a first frame displaying a first set of content and a second frame displaying a second set of content, wherein the plurality of frames share space within the GUI window;
detecting a first content transition corresponding to the first frame of the plurality of frames, the first content transition modifying the first set of content;
responsive at least to detecting the first content transition corresponding to the first frame:
increasing a first size of the first frame within the GUI window to a second size; and
decreasing a third size of a second frame, of the plurality of frames, within the GUI window to a fourth size;
wherein the method is performed by at least one device including a hardware processor.

2. The method of claim 1, further comprising:
subsequent to detecting the first content transition that modified the first set of content displayed within the first frame, analyzing the modified first set of content to determine that one or more triggering criteria for increasing the first size of the first frame within the GUI window has been met;
wherein the first size of the first frame is increased in response to determining that the one or more triggering criteria for increasing the first size of the first frame has been met.

3. The method of claim 2, wherein determining that the one or more triggering criteria has been met comprises one or more of:
determining that a level of urgency corresponding to the modified first set of content meets a threshold level of urgency;
determining that a level of priority corresponding to the modified first set of content meets a threshold level of priority; or
determining that a level of relevance corresponding to the modified first set of content meets a threshold level of relevance in relation to a task being performed by a user or a data set being accessed by the user.

4. The method of claim 1, further comprising:
subsequent to detecting the first content transition and prior to increasing the first size of the first frame:
determining that the first size of the first frame needs to be increased based on the first set of content subsequent to the first content transition;
determining that additional space for increasing the first size of the first frame is not available within the GUI; and
selecting the second frame for a size reduction, wherein an area in the GUI corresponding to a difference between the third size and the fourth size is allocated to increasing the first size of the first frame to the second size.

5. The method of claim 1, wherein increasing the first size of the first frame and decreasing the third size of the second frame results in reallocating a portion of the space within the GUI window from the second frame to the first frame.

6. The method of claim 1, further comprising:
detecting a second content transition corresponding to a third frame of the plurality of frames, the second content transition modifying a set of characteristics associated with a third set of content displayed within the third frame; and
responsive at least to detecting the second content transition corresponding to the third frame:
modifying a third size of the third frame within the GUI window.

7. The method of claim 6, wherein detecting the second content transition comprises at least one of: detecting that an age of the third set of content displayed in the third frame exceeds a threshold, detecting that an amount of time since the third set of content is displayed exceeds a threshold, or detecting a changed priority or urgency associated with the third set of content.

8. The method of claim 1, wherein, prior to detecting the first content transition, the second set of content comprises a first discrete interface element and a second discrete interface element, wherein the first discrete interface element does not overlap the second discrete interface element and the second discrete interface element does not overlap the first discrete interface element; and
wherein decreasing the third size of the second frame to the fourth size comprises stacking the first discrete interface element on top of the second discrete interface element such that at least a portion of the second discrete interface element is overlapped by the first discrete interface element.

9. The method of claim 1, wherein the first frame is a chat window, wherein detecting a first content transition comprises detecting a new chat message, and wherein increasing the first size of the first frame comprises increasing the first size to the second size to display the new chat message.

10. The method of claim 1, wherein decreasing the third size of the second frame to the fourth size comprises decreasing an amount of the second set of content displayed in the second frame at least by presenting replacing the second set of content with a summary of the second set of content in the second frame.

11. The method of claim 1, wherein decreasing the third size of the second frame to the fourth size comprises removing an interface element from the second frame.

12. One or more non-transitory computer-readable media comprising instructions that, when executed by one or more hardware processors, cause performance of operations comprising:
presenting a graphical user interface (GUI) window on a display;
presenting, within the GUI window, a plurality of frames comprising a first frame displaying a first set of content and a second frame displaying a second set of content, wherein the plurality of frames share space within the GUI window;
detecting a first content transition corresponding to the first frame of the plurality of frames, the first content transition modifying the first set of content;
responsive at least to detecting the first content transition corresponding to the first frame:
increasing a first size of the first frame within the GUI window to a second size; and
decreasing a third size of a second frame, of the plurality of frames, within the GUI window to a fourth size.

13. The one or more non-transitory computer-readable media of claim 12, the operations further comprising:
subsequent to detecting the first content transition that modified the first set of content displayed within the first frame, analyzing the modified first set of content to determine that one or more triggering criteria for increasing the first size of the first frame within the GUI window has been met;
wherein the first size of the first frame is increased in response to determining that the one or more triggering criteria for increasing the first size of the first frame has been met.

14. The one or more non-transitory computer-readable media of claim 12, the operations further comprising:
detecting a second content transition corresponding to a third frame of the plurality of frames, the second content transition modifying a set of characteristics associated with a third set of content displayed within the third frame; and
responsive at least to detecting the second content transition corresponding to the third frame:
modifying a third size of the third frame within the GUI window.

15. The one or more non-transitory computer-readable media of claim 12, wherein, prior to detecting the first content transition, the second set of content comprises a first discrete interface element and a second discrete interface element, wherein the first discrete interface element does not overlap the second discrete interface element and the second discrete interface element does not overlap the first discrete interface element; and
wherein decreasing the third size of the second frame to the fourth size comprises stacking the first discrete interface element on top of the second discrete interface element such that at least a portion of the second discrete interface element is overlapped by the first discrete interface element.

16. The one or more non-transitory computer-readable media of claim 12, wherein the first frame is a chat window, wherein detecting a first content transition comprises detecting a new chat message, and wherein increasing the first size of the first frame comprises increasing the first size to the second size to display the new chat message.

17. A system comprising:
one or more hardware processors;
one or more non-transitory computer-readable media; and
program instructions stored on the one or more non-transitory computer-readable media that, when executed by the one or more hardware processors, cause the system to:
present a graphical user interface (GUI) window on a display;
present, within the GUI window, a plurality of frames comprising a first frame displaying a first set of content and a second frame displaying a second set of content, wherein the plurality of frames share space within the GUI window;
detect a first content transition corresponding to the first frame of the plurality of frames, the first content transition modifying the first set of content;
responsive at least to detecting the first content transition corresponding to the first frame:
increase a first size of the first frame within the GUI window to a second size; and
decrease a third size of a second frame, of the plurality of frames, within the GUI window to a fourth size.

18. The system of claim 17, wherein the program instructions further cause the system to:
subsequent to detecting the first content transition that modified the first set of content displayed within the first frame, analyze the modified first set of content to determine that one or more triggering criteria for increasing the first size of the first frame within the GUI window has been met;
wherein the first size of the first frame is increased in response to determining that the one or more triggering criteria for increasing the first size of the first frame has been met.

19. The system of claim 17, wherein the program instructions further cause the system to:
detect a second content transition corresponding to a third frame of the plurality of frames, the second content transition modifying a set of characteristics associated with a third set of content displayed within the third frame; and
responsive at least to detecting the second content transition corresponding to the third frame:
modify a third size of the third frame within the GUI window.

20. The system of claim 17, wherein, prior to detecting the first content transition, the second set of content comprises a first discrete interface element and a second discrete interface element, wherein the first discrete interface element does not overlap the second discrete interface element and the second discrete interface element does not overlap the first discrete interface element; and
wherein decreasing the third size of the second frame to the fourth size comprises stacking the first discrete interface element on top of the second discrete interface element such that at least a portion of the second discrete interface element is overlapped by the first discrete interface element.
